(19) United States
(12) Patent Application Publication
(10) Pub. No.: US 2026/0245246 A1
(43) Pub. Date: Aug. 20, 2026

(54) OPTICAL MEASUREMENT DEVICE, OPTICAL MEASUREMENT METHOD AND OPTICAL MEASUREMENT PROGRAM

(71) Applicant: OTSUKA MECHATRONICS CO., LTD., Hiroshima-shi, Hiroshima (JP)

(72) Inventor: Yasuharu OBA, Hiroshima-shi, Hiroshima (JP)

(73) Assignee: OTSUKA MECHATRONICS CO., LTD., Hiroshima-shi, Hiroshima (JP)

(21) Appl. No.: 19/164,276

(22) PCT Filed: Mar. 7, 2024
(86) PCT No.: PCT/JP2024/008655

§ 371 Date: Sep. 11, 2025

(30) Foreign Application Priority Data
Mar. 13, 2023 (JP) 2023-038945

(51) Int. Cl. G06T 7/73; G01S 17/89; G06T 7/33

(52) U.S. Cl. CPC G06T 7/75; G01S 17/89; G06T 7/344; G06T 2207/10028

(57) ABSTRACT

There is provided a technique of measuring a position of a specific point set in an object to be measured. An optical measurement device includes: an acquisition unit that acquires a model including a definition of a coordinate system of a real space, model point cloud data indicating a surface shape of an object serving as a reference of an object to be measured, and a coordinate of a specific point in the real space; a search unit that searches for a pose of the model point cloud data that best aligns with three-dimensional point cloud data acquired from the object to be measured; and a calculation unit that calculates, based on the searched pose, a coordinate corresponding to the specific point on the object to be measured.

### TECHNICAL FIELD

The present invention relates to an optical measurement device, an optical measurement method and an optical measurement program.

### BACKGROUND ART

A technique of optically recognizing a position and a pose of an object has been conventionally known.

For example, Japanese Patent Laying-Open No. 2022-042103 (PTL 1) discloses a configuration capable of suppressing an influence of noise on recognition of a position and a pose of an object. Japanese Patent Laying-Open No. 2018-189510 (PTL 2) discloses a configuration that more quickly recognizes an object in a three-dimensional scene.

### CITATION LIST

### Patent Literature

PTL 1: Japanese Patent Laying-Open No. 2022-042103
PTL 2: Japanese Patent Laying-Open No. 2018-189510

### SUMMARY OF INVENTION

### Technical Problem

The above-described background art is the technique of recognizing a position and a pose of an object as a whole relative to a camera and it is not assumed to use the above-described background art to, for example, identify an absolute position of an object.

An object of the present invention is to provide a technique of measuring a position of a specific point set in an object to be measured.

### Solution to Problem

(Configuration 1) An optical measurement device according to an aspect of the present invention includes: a holding unit that holds a model including a definition of a coordinate system of a real space, model point cloud data indicating a surface shape of an object serving as a reference of an object to be measured, and a coordinate of a specific point in the real space; a search unit that searches for a pose of the model point cloud data that best aligns with three-dimensional point cloud data acquired from the object to be measured; and a calculation unit that calculates, based on the searched pose, a coordinate corresponding to the specific point on the object to be measured.

(Configuration 2) In Configuration 1, the search unit may search for the pose that best aligns with the three-dimensional point cloud data, by translating and rotating the model point cloud data.

(Configuration 3) In Configuration 1 or 2, the search unit may search for the pose that best aligns with the three-dimensional point cloud data, by using downsampled data derived from the model point cloud data and downsampled data derived from the model point cloud data.

(Configuration 4) In any one of Configurations 1 to 3, the search unit may extract a predetermined number of pose candidates in descending order of a degree of similarity between the three-dimensional point cloud data and the model point cloud data.

(Configuration 5) In Configuration 4, the search unit may evaluate uniqueness of a pose candidate having a highest degree of similarity, of the predetermined number of pose candidates, with respect to the other pose candidates.

(Configuration 6) In any one of Configurations 1 to 5, the optical measurement device may further include a model generation unit that determines, as the model point cloud data, partial data corresponding to one or more designated areas, with respect to three-dimensional point cloud data acquired from the object serving as the reference of the object to be measured.

(Configuration 7) In any one of Configurations 1 to 6, the search unit may reflect uncertainty present in the three-dimensional point cloud data and generate a plurality of pieces of three-dimensional point cloud data from the three-dimensional point cloud data, calculate a coordinate corresponding to the specific point from each of the generated plurality of pieces of three-dimensional point cloud data, and calculate uncertainty present in the calculated coordinate, based on variation in the calculated coordinate.

(Configuration 8) An optical measurement method according to another aspect of the present invention includes: acquiring a model including a definition of a coordinate system of a real space, model point cloud data indicating a surface shape of an object serving as a reference of an object to be measured, and a coordinate of a specific point in the real space; searching for a pose of the model point cloud data that best aligns with three-dimensional point cloud data acquired from the object to be measured; and calculating, based on the searched pose, a coordinate corresponding to the specific point on the object to be measured.

(Configuration 9) An optical measurement program according to another aspect of the present invention causes a computer to perform: acquiring a model including a definition of a coordinate system of a real space, model point cloud data indicating a surface shape of an object serving as a reference of an object to be measured, and a coordinate of a specific point in the real space; searching for a pose of the model point cloud data that best aligns with three-dimensional point cloud data acquired from the object to be measured; and calculating, based on the searched pose, a coordinate corresponding to the specific point on the object to be measured.

### Advantageous Effects of Invention

According to an embodiment of the present invention, a position of a specific point set in an object to be measured can be measured in a non-contact manner.

### BRIEF DESCRIPTION OF DRAWINGS

FIG. 1 is a schematic view showing an exemplary hardware configuration of an optical measurement device according to the present embodiment.

FIG. 2 is a diagram for illustrating an example of a process procedure of an optical measurement method according to the present embodiment.

FIG. 3 is a diagram for illustrating the example of the process procedure of the optical measurement method according to the present embodiment.

FIG. 4 is a diagram for illustrating the example of the process procedure of the optical measurement method according to the present embodiment.

FIG. 5 is a diagram for illustrating the example of the process procedure of the optical measurement method according to the present embodiment.

FIG. 6 is a diagram for illustrating the example of the process procedure of the optical measurement method according to the present embodiment.

FIG. 7 is a diagram for illustrating the example of the process procedure of the optical measurement method according to the present embodiment.

FIG. 8 is a diagram for illustrating the example of the process procedure of the optical measurement method according to the present embodiment.

FIG. 9 is a flowchart showing an example of a process procedure related to model generation in the optical measurement method according to the present embodiment.

FIG. 10 is a flowchart showing an example of a process procedure related to measurement of a position of a specific point in the optical measurement method according to the present embodiment.

FIG. 11 is a diagram showing an exemplary process of approximate matching in the optical measurement method according to the present embodiment.

FIG. 12 is a diagram showing an exemplary process of sparse pose refinement in the optical measurement method according to the present embodiment.

FIG. 13 is a diagram showing an exemplary process of dense pose refinement in the optical measurement method according to the present embodiment.

FIG. 14 is a diagram showing an exemplary process result of dense pose refinement in the optical measurement method according to the present embodiment.

FIG. 15 is a schematic view showing an exemplary software configuration of the optical measurement device according to the present embodiment.

FIG. 16 is a diagram for illustrating a point cloud spacing between sample points in the optical measurement method according to the present embodiment.

FIG. 17 is a diagram showing an example of a search result by the optical measurement method according to the present embodiment.

FIG. 18 is a schematic view showing an example of a headlight inspection device.

FIG. 19 is a schematic view showing an example of an inspection device for an advanced driver assistance system (ADAS).

FIG. 20 is a diagram for illustrating a method of evaluating uncertainty present in a coordinate of the specific point in the optical measurement method according to the present embodiment.

### DESCRIPTION OF EMBODIMENTS

An embodiment of the present invention will be described in detail with reference to the drawings. The same or corresponding portions in the drawings are denoted by the same reference characters and description thereof will not be repeated.

An optical measurement method according to the present embodiment is a method of measuring a position, on a real space, of any point (hereinafter also referred to as “specific point”) set on any object to be measured. The specific point is set relative to the object to be measured.

“Real space” herein refers to an actually existing space having a predefined coordinate system.

### <A. Exemplary Device Configuration>

First, an example of a device configuration for implementing the optical measurement method according to the present embodiment will be described.

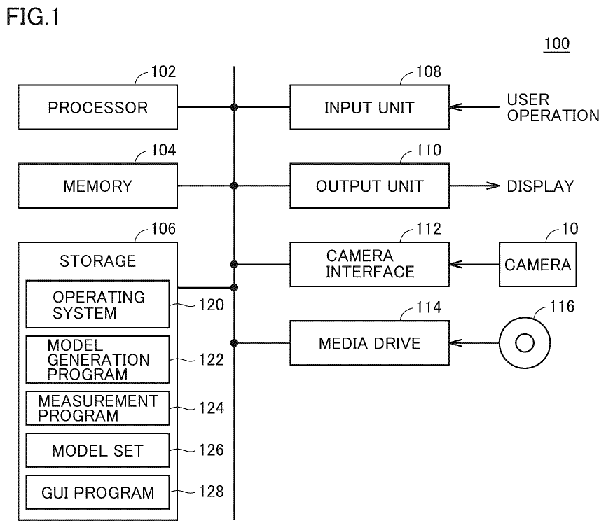

FIG. 1 is a schematic view showing an exemplary hardware configuration of an optical measurement device according to the present embodiment.

Referring to FIG. 1, an optical measurement device 100 includes one or more processors 102, a memory 104, a storage 106, an input unit 108, an output unit 110, a camera interface 112, and a media drive 114.

Processor 102 reads one or more programs stored in storage 106 into memory 104 and executes the one or more programs. Processor 102 is implemented by, for example, a central processing unit (CPU), a graphics processing unit (GPU) or the like. Processor 102 may include a hardwired logic circuit such as a field-programmable gate array (FPGA) or an application specific integrated circuit (ASIC).

Memory 104 functions as a working memory for execution of the programs by processor 102. Memory 104 is implemented by, for example, a dynamic random access memory (DRAM), a static random access memory (SRAM) or the like.

Storage 106 stores the programs (set of computer readable instructions) to be executed by processor 102 and data required for processing. Storage 106 is implemented by, for example, a non-transitory computer readable medium such as a hard disk or a flash memory. Storage 106 stores an operating system (OS) 120, a model generation program 122, a measurement program 124, a model set 126, and a graphical user interface (GUI) program 128.

Operating system 120 includes a computer readable instruction for implementing an environment where processor 102 executes the programs. Model generation program 122 includes a computer readable instruction for generating a model 36. Measurement program 124 includes a computer readable instruction for measuring a position of a specific point on an object to be measured. Model set 126 includes one or more models 36. GUI program 128 includes a computer readable instruction for providing user interaction required for processing.

Input unit 108 accepts a user operation. Input unit 108 may include an input device such as a keyboard or a mouse, or may include a communication interface for receiving a signal or data indicating the user operation from the input device.

Output unit 110 outputs a result of execution of the programs by processor 102, and the like. Output unit 110 may include an output device such as a display, or may include a communication interface for transmitting information to be output to the output device.

Camera interface 112 acquires image data from one or more cameras 10. In the optical measurement method according to the present embodiment, three-dimensional point cloud data of the object to be measured may only be acquired. Therefore, camera interface 112 acquires information for acquiring the three-dimensional point cloud data and/or the three-dimensional point cloud data itself not only from camera 10 but also from any device.

Media drive 114 reads a program and/or data required for processing in optical measurement device 100 from a non-transitory computer readable medium (such as, for example, an optical disk 116) and stores the program and/or the data in storage 106. The program and/or the data required for processing in optical measurement device 100 may be downloaded from a server device on a network. Model 36 may also be downloaded as appropriate from the server device on the network.

“Optical measurement device” herein may be a single device, or may be a set of a plurality of devices. A part of processing may be implemented by using a computing resource such as a cloud.

### <B. Acquisition of Three-Dimensional Point Cloud Data>

In the optical measurement method according to the present embodiment, the three-dimensional point cloud data is information that defines a surface shape of an object to be measured or an object having substantially the same shape as that of the object to be measured. The three-dimensional point cloud data includes a coordinate (x, y, z) of each point present on a surface. The coordinate of each point included in the three-dimensional point cloud data is defined in a coordinate system relative to camera 10, for example.

The three-dimensional point cloud data may be acquired by using any methods. For example, a passive scan method using a stereo camera may be adopted. Alternatively, an active scan method such as time of flight (TOF) or triangulation may be adopted. An active stereo camera and spatial coding are known as triangulation. Random dot and feature-based matching such as fringe projection are, for example, known as the spatial coding. Furthermore, temporal coding, a laser profiling method (e.g., beam scanning or conveyor) or the like may be adopted.

As described above, as long as the three-dimensional point cloud data can be acquired, any camera 10 and any image pickup method may be adopted. This makes it possible to relax restrictions of hardware that can be used in the optical measurement method according to the present embodiment.

### <C. Overall Process Procedure>

Next, an example of the optical measurement method according to the present embodiment will be described.

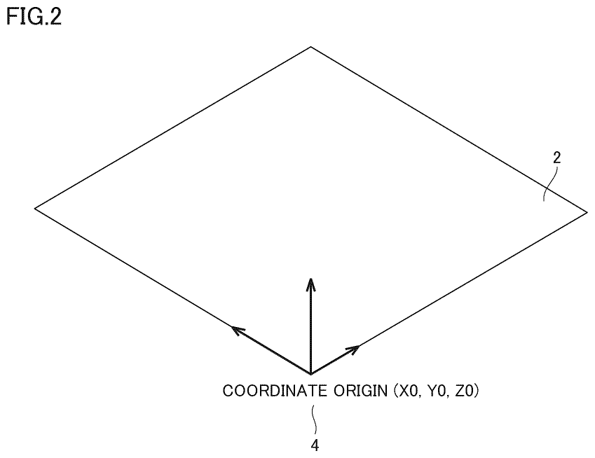

Each of FIGS. 2 to 8 is a diagram for illustrating an example of a process procedure of the optical measurement method according to the present embodiment.

First, any real space 2 is defined and a coordinate origin 4 of real space 2 is defined (see FIG. 2). Real space 2 is, for example, a space associated with any inspection device.

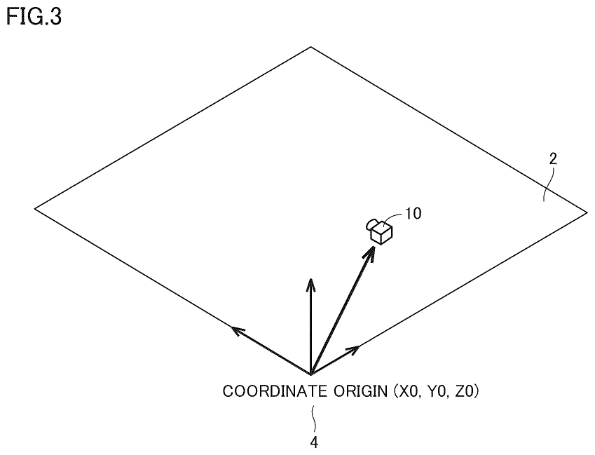

Next, camera 10 is disposed at any position in real space 2 (see FIG. 3). Camera 10 picks up an image of an object to be measured or an object having substantially the same shape as that of the object to be measured, and generates three-dimensional point cloud data (hereinafter also simply referred to as “point cloud data”). At this time, a positional relationship between disposed camera 10 and coordinate origin 4 is defined.

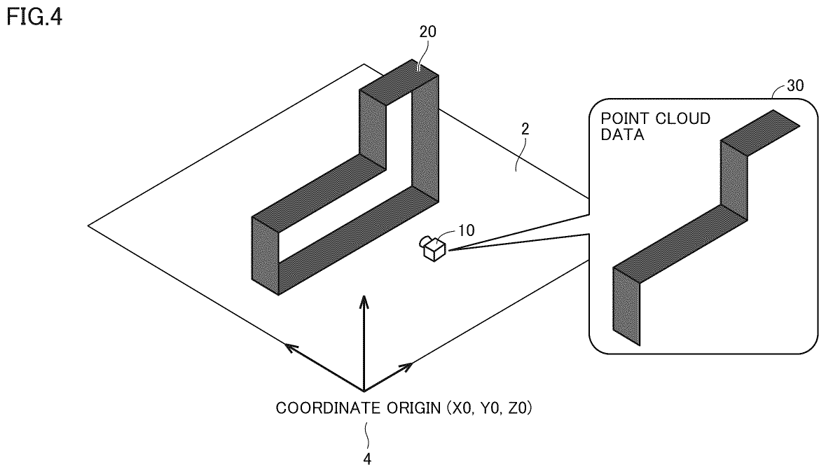

Next, an image of the object (hereinafter also referred to as “reference 20”) having substantially the same shape as that of the object to be measured is picked up by camera 10 and three-dimensional point cloud data of reference 20 (hereinafter also referred to as “reference point cloud data 30”) is acquired. Reference point cloud data 30 defines a surface shape of reference 20 (see FIG. 4).

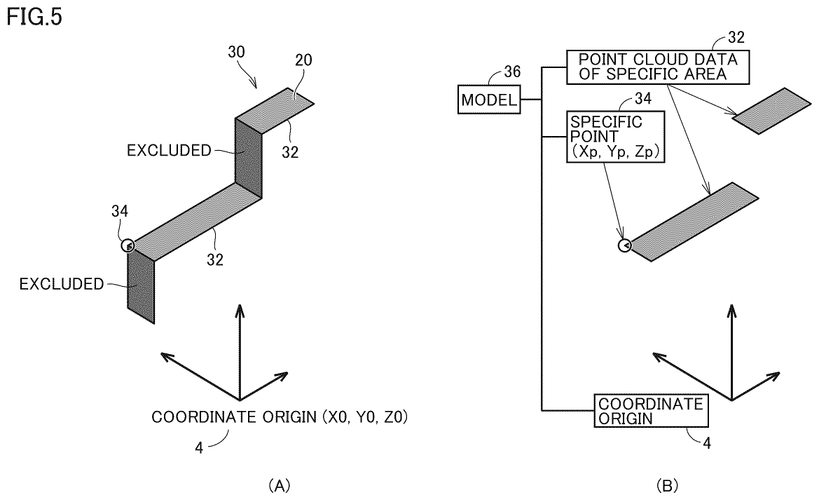

Next, as shown in FIG. 5(A), an area (hereinafter also referred to as “specific area”) used to search for a pose (a position and an angle, or a position) of the object to be measured is determined and three-dimensional point cloud data corresponding to one or more specific areas (hereinafter also referred to as “model point cloud data 32”) is extracted from reference point cloud data 30. That is, of model point cloud data 32, point cloud data that does not need to be used for searching for the object to be measured or point cloud data that may be noise in searching for the object to be measured is excluded.

In this way, optical measurement device 100 determines, as model point cloud data 32, partial data corresponding to one or more designated specific areas, with respect to reference point cloud data 30.

In addition, a point to be measured (hereinafter also referred to as “specific point 34”) is designated in reference point cloud data 30.

Finally, as shown in FIG. 5(B), coordinate origin 4, model point cloud data 32, and information about specific point 34 are registered as model 36. Coordinate origin 4 is a definition of a coordinate system of real space 2. Model point cloud data 32 indicates at least a part of a surface shape of an object (reference 20) serving as a reference of an object to be measured 40. The information about specific point 34 includes a coordinate of specific point 34 in real space 2. More specifically, model 36 includes a coordinate p0(Xp0, Yp0, Zp0) of specific point 34 in a coordinate system relative to coordinate origin 4 (hereinafter also referred to as “real space coordinate system”).

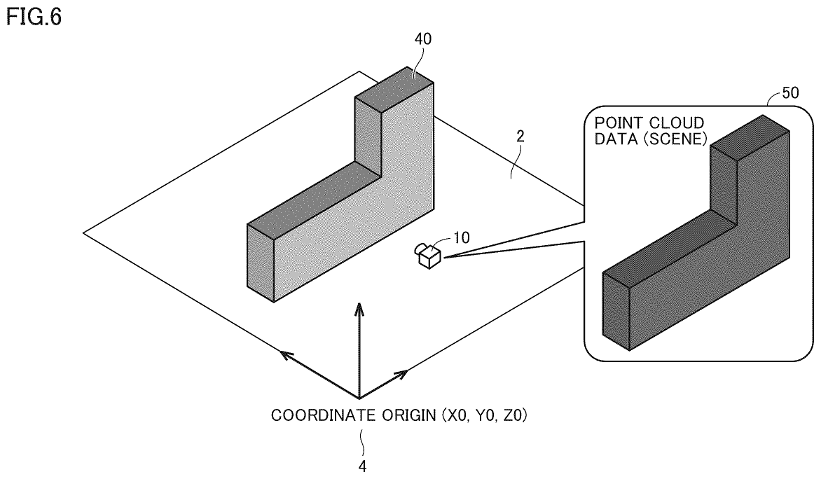

Next, in actual measurement, camera 10 picks up an image of object to be measured 40 and point cloud data of object to be measured 40 (hereinafter also referred to as “scene point cloud data 50”) is generated (see FIG. 6). The position of camera 10 (i.e., the positional relationship between disposed camera 10 and coordinate origin 4) in real space 2 is assumed to be the same as that when model 36 is registered.

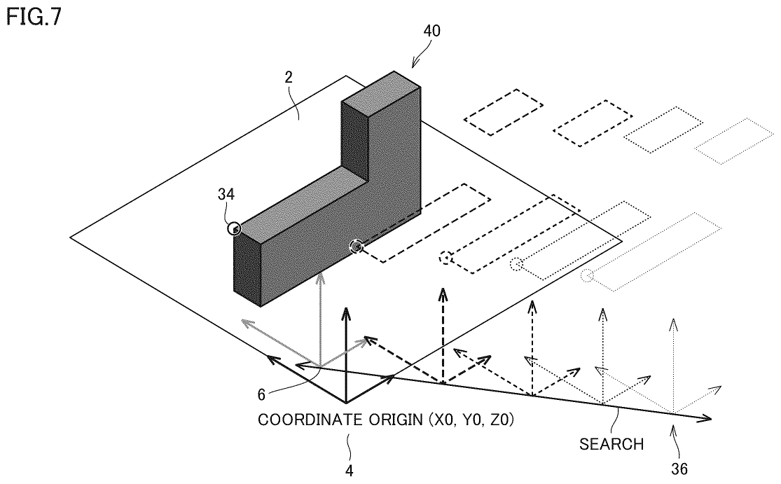

Optical measurement device 100 searches for a pose of model point cloud data 32 that best aligns with scene point cloud data 50 acquired from object to be measured 40 (see FIG. 7). In other words, model point cloud data 32 (or the real space coordinate system defined in model 36) is translated and/or rotated to match with scene point cloud data 50.

Although FIG. 7 shows the example of translating model point cloud data 32 for the sake of convenience in description, the position and the angle of model point cloud data 32 may be changed in any way. In this way, the point cloud data that best aligns with model point cloud data 32 of model 36 is searched from scene point cloud data 50. In the example shown in FIG. 7, by moving coordinate origin 4 of model 36 to a coordinate origin 6, model point cloud data 32 becomes most similar to the point cloud data included in scene point cloud data 50.

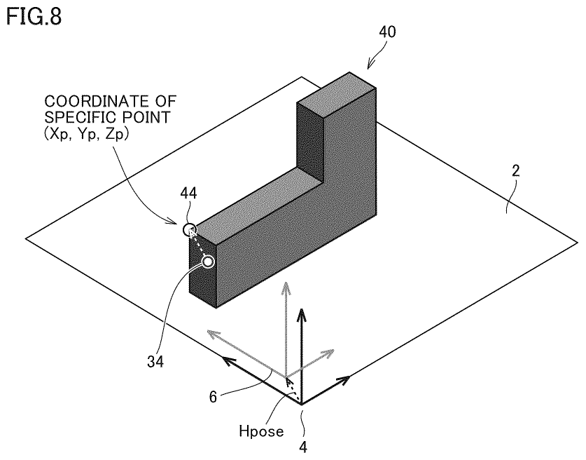

Referring to FIG. 8, based on information in the state where model point cloud data 32 of model 36 best aligns with the point cloud data included in scene point cloud data 50, a coordinate of a specific point 44 (point corresponding to specific point 34) on object to be measured 40 is calculated. That is, optical measurement device 100 calculates, based on the searched pose, the coordinate corresponding to specific point 44 on object to be measured 40.

More specifically, by transforming the coordinate of specific point 34 on model 36 based on a positional relationship between real space 2 (real space coordinate system) where model 36 is acquired and a space (coordinate system relative to coordinate origin 6 (hereinafter also referred to as “scene coordinate system”)) that best aligns with the point cloud data included in scene point cloud data 50, the coordinate of specific point 44 on object to be measured 40 in real space 2 is calculated.

A specific exemplary procedure for calculating the coordinate of specific point 44 on object to be measured 40 in real space 2 will be described.

In the above-described search, a homogeneous transformation matrix Hpose for transforming the real space coordinate system relative to coordinate origin 4 into the scene coordinate system relative to coordinate origin 6 is calculated. Homogeneous transformation matrix Hpose is as follows.

$$Hpose = [ TransX , TransY , TransZ , RotX , RotY , RotZ ]$$

The rotation follows the yaw-pitch-roll (YPR) Convention.

Homogeneous transformation matrix Hpose can also be separated into a translation matrix H (T) and a rotation matrix H(R) as shown below.

$$\begin{matrix}Hpose = [ \begin{matrix} & R & & T \\ 0 & 0 & 0 & 1\end{matrix} ] = [ \begin{matrix} & TransX \\ R ( RotX , RotY , RptZ ) & TransY \\ & TransZ \\ 000 & 1\end{matrix} ] \\ = [ \begin{matrix}1 & 0 & 0 & TransX \\ 0 & 1 & 0 & TransY \\ 0 & 0 & 1 & TransZ \\ 0 & 0 & 0 & 1\end{matrix} ] \cdot [ \begin{matrix} & 0 \\ R ( RotX , RotY , RotZ ) & 0 \\ & 0 \\ 000 & 0\end{matrix} ] \\ = H ( T ) \cdot H ( R )\end{matrix} \qquad [ Math . 1 ]$$

By translating and rotating specific point 34 on model 36 in accordance with the homogeneous transformation matrix, the coordinate of specific point 44 on object to be measured 40 in the real space coordinate system is calculated. Since model point cloud data 32 and the point cloud data included in scene point cloud data 50 are most similar to each other in the scene coordinate system, the coordinate after coordinate transformation coincides with the coordinate of specific point 44 on object to be measured 40. That is, by mapping the coordinate of specific point 34 on model 36 to the scene coordinate system using the homogeneous transformation matrix, the coordinate of specific point 44 on object to be measured 40 is calculated.

More specifically, a coordinate p(Xp, Yp, Zp) of specific point 44 on object to be measured 40 is calculated from the coordinate (Xp0, Yp0, Zp0) of specific point 34 on model 36 in accordance with a transformation formula shown below.

$$( \begin{matrix}p \\ 1\end{matrix} ) = Hpose \cdot ( \begin{matrix}p 0 \\ 1\end{matrix} ) \qquad [ Math . 2 ]$$

When there is a difference (translation) between coordinate origin 4 of real space 2 when generating model 36 and the coordinate origin of the real space where scene point cloud data 50 is acquired, the coordinate may be corrected to reflect the difference.

For example, assuming that the difference between the coordinate origins is Offset[OffsetX, OffsetY, OffsetZ], the coordinate p(Xp, Yp, Zp) of specific point 44 on object to be measured 40 is calculated from the coordinate (Xp0, Yp0, Zp0) of specific point 34 on model 36 in accordance with a transformation formula shown below.

$$( \begin{matrix}p \\ 1\end{matrix} ) = Hpose \cdot ( \begin{matrix}p 0 \\ 1\end{matrix} ) + ( \begin{matrix}Offset ( OffsetX , OffsetY , OffsetZ ) \\ 1\end{matrix} ) \qquad [ Math . 3 ]$$

### <D. Process Procedure>

Next, an example of a process procedure of the optical measurement method according to the present embodiment will be described.

### (d1: Model Generation)

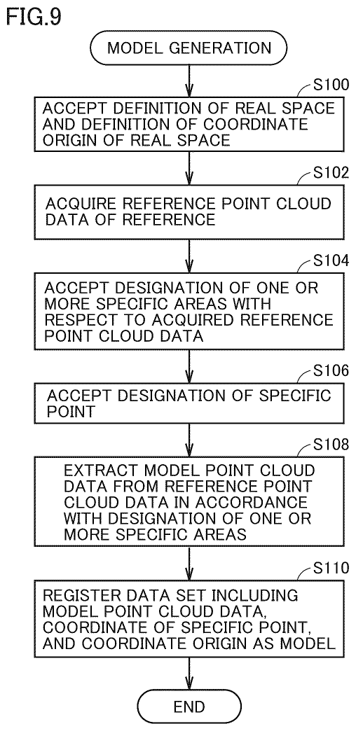

FIG. 9 is a flowchart showing an example of a process procedure related to model generation in the optical measurement method according to the present embodiment. Each step shown in FIG. 9 may be performed by execution of model generation program 122 (FIG. 1) by one or more processors 102 of optical measurement device 100.

Referring to FIG. 9, optical measurement device 100 accepts a definition of real space 2 and a definition of coordinate origin 4 of real space 2 (step S100). Then, optical measurement device 100 acquires reference point cloud data 30 of reference 20 (step S102).

Optical measurement device 100 accepts designation of one or more specific areas with respect to acquired reference point cloud data 30 (step S104) and accepts designation of a specific point (step S106). Optical measurement device 100 extracts model point cloud data 32 from reference point cloud data 30 in accordance with the designation of the one or more specific areas (step S108). Then, optical measurement device 100 registers a data set including model point cloud data 32, a coordinate of specific point 34, and coordinate origin 4 as model 36 (step S110). In this way, the process of registering one model 36 ends.

When a plurality of models 36 are registered, the process shown in FIG. 9 is repeated a number of times corresponding to the number of models 36.

### (d2: Measurement of Position of Specific Point)

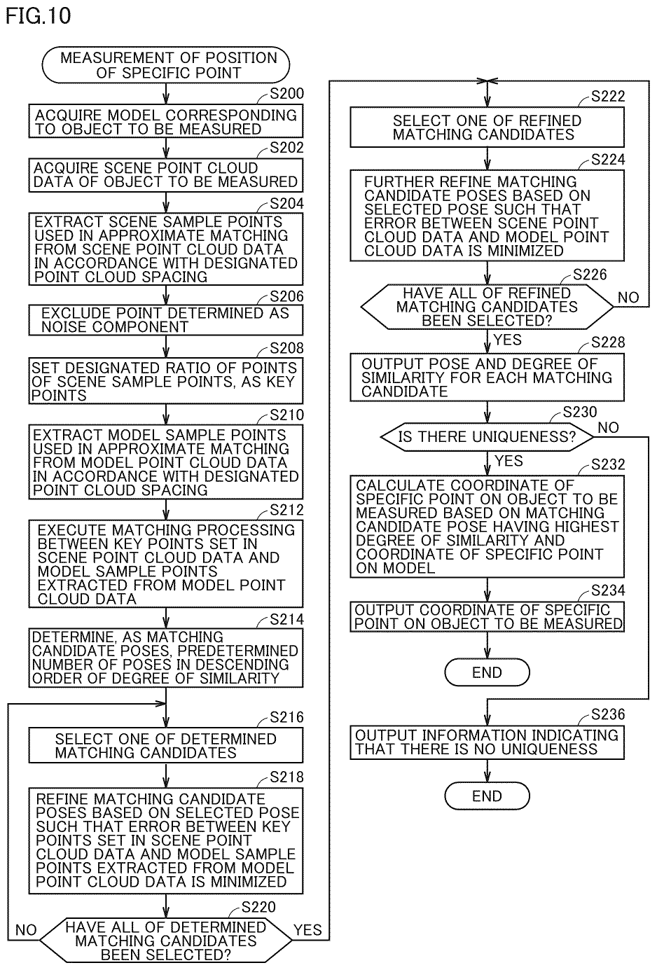

FIG. 10 is a flowchart showing an example of a process procedure related to measurement of a position of the specific point in the optical measurement method according to the present embodiment. Each step shown in FIG. 10 may be performed by execution of measurement program 124 (FIG. 1) by one or more processors 102 of optical measurement device 100.

Referring to FIG. 10, optical measurement device 100 acquires model 36 corresponding to object to be measured 40 (step S200). Optical measurement device 100 acquires scene point cloud data 50 of object to be measured 40 (step S202). Then, optical measurement device 100 searches for a pose of model point cloud data 32 that best aligns with scene point cloud data 50 acquired from object to be measured 40. That is, optical measurement device 100 searches for a portion that best aligns with model point cloud data 32 from scene point cloud data 50 (surface matching).

Optical measurement device 100 may search for the pose of model point cloud data 32 that best aligns with scene point cloud data 50, by using downsampled data derived from scene point cloud data 50 and downsampled data derived from model point cloud data 32 (approximate matching and sparse pose refinement described below).

First, optical measurement device 100 executes the approximate matching.

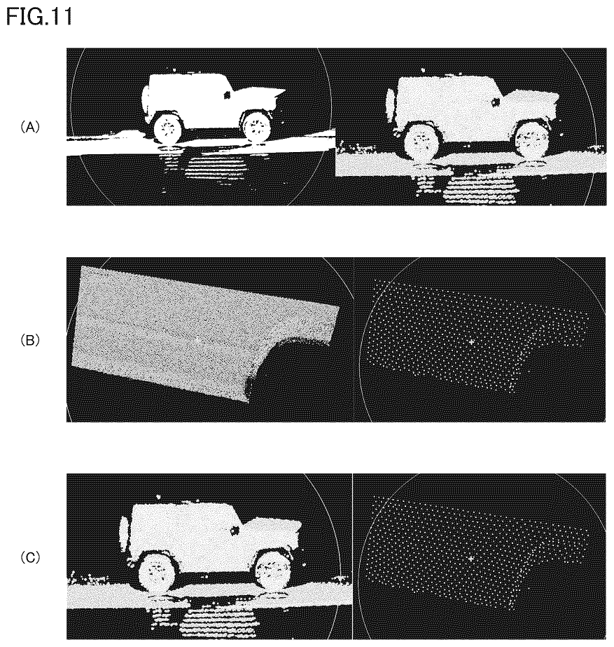

FIG. 11 is a diagram showing an exemplary process of the approximate matching in the optical measurement method according to the present embodiment.

Specifically, optical measurement device 100 extracts scene sample points used in the approximate matching from scene point cloud data 50 in accordance with a designated point cloud spacing (step S204) and excludes a point determined as a noise component (step S206). Furthermore, optical measurement device 100 sets a designated ratio of points, of the scene sample points from which the noise component has been excluded, as key points (step S208).

The left figure in FIG. 11(A) shows an example of scene point cloud data 50 and the right figure in FIG. 11(A) shows examples of the scene sample points and the key points extracted from scene point cloud data 50.

In addition, optical measurement device 100 extracts model sample points used in the approximate matching from model point cloud data 32 in accordance with a designated point cloud spacing (step S210).

The left figure in FIG. 11(B) shows an example of model point cloud data 32 and the right figure in FIG. 11(B) shows an example of the model sample points extracted from model point cloud data 32.

Processing in steps S204 to S208 and processing in step S210 may be performed in any order. Two types of processing may be performed in parallel.

Then, optical measurement device 100 executes matching processing between the key points set in scene point cloud data 50 and the model sample points extracted from model point cloud data 32 (step S212).

The left figure in FIG. 11(C) shows an example of the key points extracted from scene point cloud data 50 and the right figure in FIG. 11(C) shows an example of the model sample points extracted from model point cloud data 32.

In the matching processing, optical measurement device 100 sequentially updates a pose (a position and an angle, or a position) of model point cloud data 32 (model sample points), and calculates a degree of similarity in each pose and searches for a pose having a high degree of similarity. Optical measurement device 100 determines, as matching candidate poses, a predetermined number of (e.g., nine) poses in descending order of the degree of similarity (step S214). In this way, optical measurement device 100 may extract a predetermined number of matching candidates (pose candidates) in descending order of the degree of similarity between scene point cloud data 50 and model point cloud data 32.

Next, optical measurement device 100 executes the sparse pose refinement.

Specifically, optical measurement device 100 selects one of the determined matching candidates (step S216) and refines the matching candidate poses based on the selected pose such that an error between the key points set in scene point cloud data 50 (step S208) and the model sample points extracted from model point cloud data 32 (step S210) is minimized (step S218).

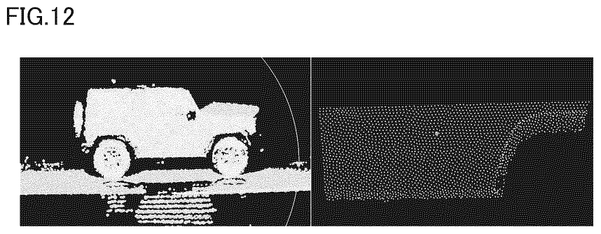

FIG. 12 is a diagram showing an exemplary process of the sparse pose refinement in the optical measurement method according to the present embodiment. The left figure in FIG. 12 shows an example of the key points extracted from scene point cloud data 50 and the right figure in FIG. 12 shows an example of the model sample points (after the pose refinement) extracted from model point cloud data 32.

Optical measurement device 100 determines whether all of the determined matching candidates have been selected (step S220). When some of the determined matching candidates have not been selected (NO in step S220), processing in step S216 and the subsequent step is repeated.

When all of the determined matching candidates have been selected (YES in step S220), the sparse pose refinement ends. Each of the matching candidate poses is refined by the sparse pose refinement.

Finally, optical measurement device 100 executes dense pose refinement.

Specifically, optical measurement device 100 selects one of the refined matching candidates (step S222) and further refines the matching candidate poses based on the selected pose such that an error between scene point cloud data 50 and model point cloud data 32 is minimized (step S224).

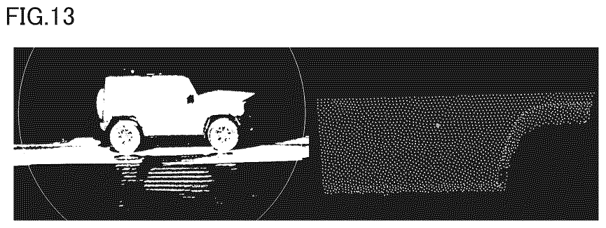

FIG. 13 is a diagram showing an exemplary process of the dense pose refinement in the optical measurement method according to the present embodiment. The left figure in FIG. 13 shows an example of scene point cloud data 50 and the right figure in FIG. 13 shows an example of model point cloud data 32.

Optical measurement device 100 determines whether all of the refined matching candidates have been selected (step S226). When some of the refined matching candidates have not been selected (NO in step S226), processing in step S222 and the subsequent step is repeated.

When all of the refined matching candidates have been selected (YES in step S226), the dense pose refinement ends.

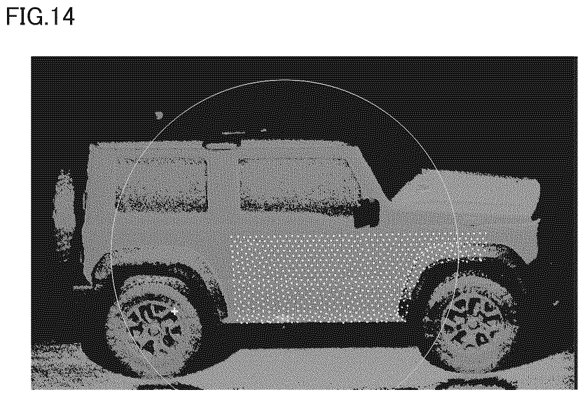

FIG. 14 is a diagram showing an exemplary process result of the dense pose refinement in the optical measurement method according to the present embodiment. As shown in FIG. 14, model point cloud data 32 is searched from scene point cloud data 50.

After the dense pose refinement is executed, optical measurement device 100 outputs the pose and the degree of similarity for each matching candidate (step S228). The pose may be output in the form of homogeneous transformation matrix Hpose and the degree of similarity may be output in the form of a score.

For example, the score can be calculated as score=(the number of points in scene point cloud data 50 that correspond to (or match with) points in model point cloud data 32)/(the total number of points in model point cloud data 32 included in model 36). That is, the ratio of corresponding points between scene point cloud data 50 and model point cloud data 32, relative to the total number of model point cloud data 32 may be calculated as the score. In this case, the score takes a value within a range from 0 to 1.

Then, optical measurement device 100 executes a uniqueness determination process. Specifically, optical measurement device 100 determines whether there is uniqueness, based on the degree of similarity for each matching candidate (step S230).

When optical measurement device 100 determines that there is uniqueness (YES in step S230), optical measurement device 100 calculates a coordinate of specific point 44 on object to be measured 40 based on the matching candidate pose having the highest degree of similarity and the coordinate of specific point 34 on model 36 (step S232), and outputs the calculated coordinate of specific point 44 on object to be measured 40 (step S234). That is, optical measurement device 100 calculates, based on the searched pose, the coordinate corresponding to specific point 44 on object to be measured 40. Then, the process ends.

On the other hand, when optical measurement device 100 determines that there is no uniqueness (NO in step S230), optical measurement device 100 outputs information indicating that there is no uniqueness (step S236). Then, the process ends.

### <E. Software Configuration>

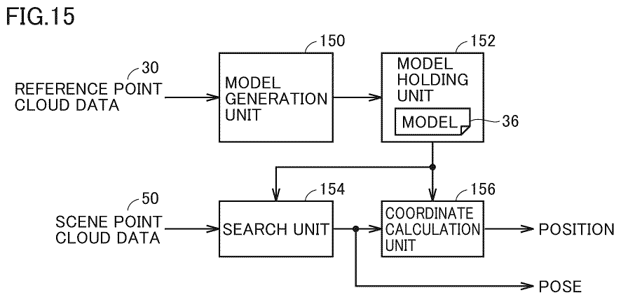

FIG. 15 is a schematic view showing an exemplary software configuration of the optical measurement device according to the present embodiment. The exemplary software configuration shown in FIG. 15 may, for example, be implemented by execution of model generation program 122 and measurement program 124 (both in FIG. 1) by one or more processors 102 of optical measurement device 100.

Referring to FIG. 15, optical measurement device 100 includes, for example, a model generation unit 150, a model holding unit 152, a search unit 154, and a coordinate calculation unit 156.

Model generation unit 150 corresponds to a generation unit, and acquires reference point cloud data 30 of reference 20 and generates model 36 in accordance with a user operation.

Model holding unit 152 corresponds to a holding unit or an acquisition unit, and holds model 36 generated by model generation unit 150 and/or model 36 acquired from the server device or the like.

Search unit 154 searches for a pose of model point cloud data 32 included in model 36, such that the pose best aligns with scene point cloud data 50 of object to be measured 40. The pose searched by search unit 154 may be output as it is.

Coordinate calculation unit 156 corresponds to a calculation unit, and calculates a coordinate of specific point 44 on object to be measured 40 based on the pose searched by search unit 154.

### <F. Optimization of Point Cloud Spacing Between Sample Points>

Next, optimization of a point cloud spacing between the sample points extracted from model point cloud data 32 and scene point cloud data 50 will be described.

As described above, in the approximate matching, model sample points and scene sample points extracted by downsampling model point cloud data 32 and scene point cloud data 50 at a designated point cloud spacing, respectively, are used. The point cloud spacing for extracting these sample points will be described.

A reason for using the model sample points and the scene sample points in the matching is to shorten a time required for search (matching execution time). By downsampling the point cloud data at the point cloud spacing, the number of search targets decreases, and thus, the time required for search can be shortened.

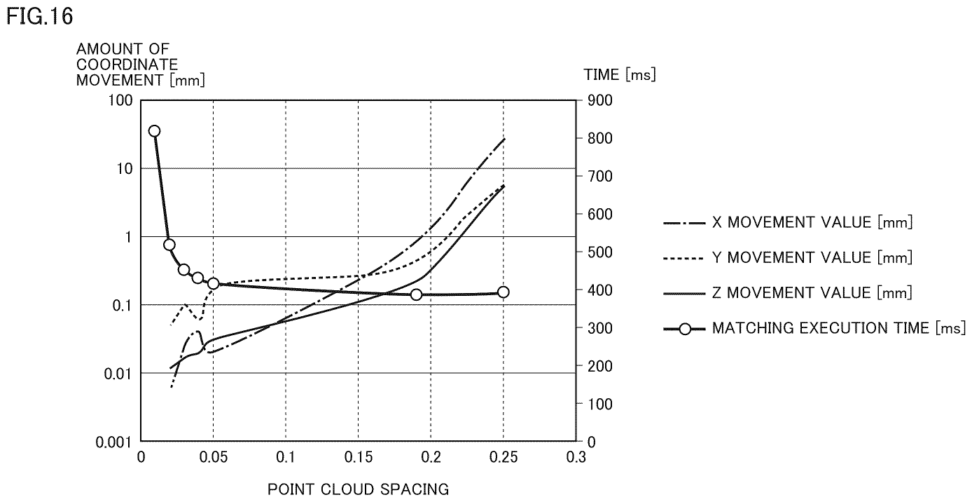

FIG. 16 is a diagram for illustrating the point cloud spacing between the sample points in the optical measurement method according to the present embodiment. FIG. 16 shows examples of an amount of coordinate movement (logarithmic scale) and the matching execution time at different point cloud spacings. The point cloud spacing indicates an arbitrarily standardized distance. The amount of coordinate movement indicates a difference (components of X, Y and Z axes) between the position of specific point 44 measured provisionally by the approximate matching and the finally determined position of specific point 44.

In FIG. 16, an initial value of the point cloud spacing is set at 0.01 as an example. The amount of coordinate movement at the initial value of the point cloud spacing is not shown because it is zero.

Referring to FIG. 16, the point cloud spacing can be optimized based on, for example, the time required for search (matching execution time) and a difference in position of specific point 44 (i.e., an amount of refinement by the sparse pose refinement and the dense pose refinement). In the example shown in FIG. 16, the point cloud spacing may be set within a range of 0.05 to 0.15.

The point cloud spacing may be determined by focusing attention only on the time required for search, or the point cloud spacing may be determined by focusing attention only on the difference in position of specific point 44.

The point cloud spacing for extracting the model sample points and the point cloud spacing for extracting the scene sample points do not need to be the same.

In the measurement of the position of the specific point (FIG. 10), the point cloud spacing may be designated in advance, or may be set as the need arises. The optimized value of the point cloud spacing may be included in corresponding model 36.

### <G. Uniqueness Determination Process>

Next, an exemplary process of a uniqueness determination process (step S230) in the optical measurement method according to the present embodiment will be described.

In the uniqueness determination process, it is determined whether a position of point cloud data that best aligns with model point cloud data 32, of scene point cloud data 50, is determined uniquely. In order to determine this uniqueness, it is determined whether a degree of similarity of the portion searched as being most similar is more prominent than degrees of similarity of the other portions. That is, optical measurement device 100 evaluates uniqueness of a matching candidate having the highest degree of similarity, of a predetermined number of matching candidates (pose candidates), with respect to the other matching candidates.

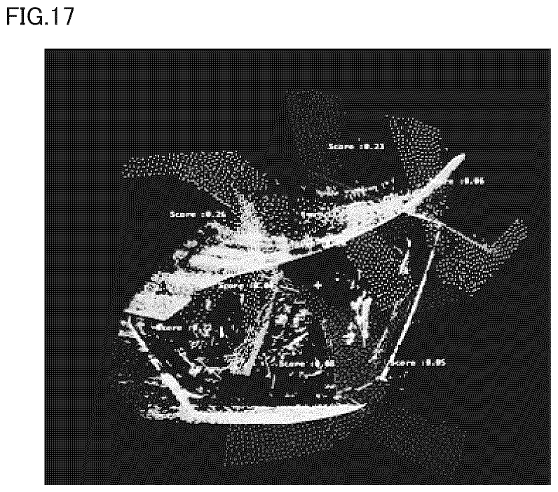

FIG. 17 is a diagram showing an example of a search result by the optical measurement method according to the present embodiment. FIG. 17 shows eight matching candidates as an example.

In the uniqueness determination process, the degree of similarity (score) is statistically evaluated for each of the searched matching candidates. An interquartile range can, for example, be used in statistical evaluation.

More specifically, a third quartile is calculated from the degrees of similarity of all of the searched matching candidates. Then, a determination threshold value calculated from the calculated third quartile and the degree of similarity of the No. 1 matching candidate are compared. When the degree of similarity of the No. 1 matching candidate is larger than the determination threshold value, it can be determined that the search result has uniqueness.

The following is an exemplary result in which degrees of similarity of nine matching candidates are arranged in ascending order.

TABLE 1

| No. 1 | No. 2 | No. 3 | No. 4 | No. 5 | No. 6 | No. 7 | No. 8 | No. 9 |
|---|---|---|---|---|---|---|---|---|
| 0.120 | 0.124 | 0.127 | 0.131 | 0.148 | 0.275 | 0.300 | 0.345 | 0.618 |
| | | Q1 | | Q2 | | Q3 | | |

According to the table above, the respective values can be calculated as described below.

$$First quartile Q 1 ( 25 \% ) = 0.127$$

$$Median value Q 2 = 0.148$$

$$Third quartile Q 3 ( 75 \% ) = 0.3$$

Assuming that a determination threshold value for an outlier is “Q3+(Q3−Q1)×1.5”, the determination threshold value can be calculated as 0.560.

Since the degree of similarity of the No. 9 matching candidate is 0.618 and is larger than 0.560, which is the determination threshold value for the outlier, it can be determined that this has uniqueness (i.e., corresponds to the outlier).

Another known method may be used as the method of determining uniqueness for a set of matching candidates from which a matching candidate having a highest degree of similarity is searched.

### <H. Application Examples>

Next, exemplary applications of the optical measurement method according to the present embodiment will be described. The optical measurement method according to the present embodiment can be used not only in applications described below but also in any applications.

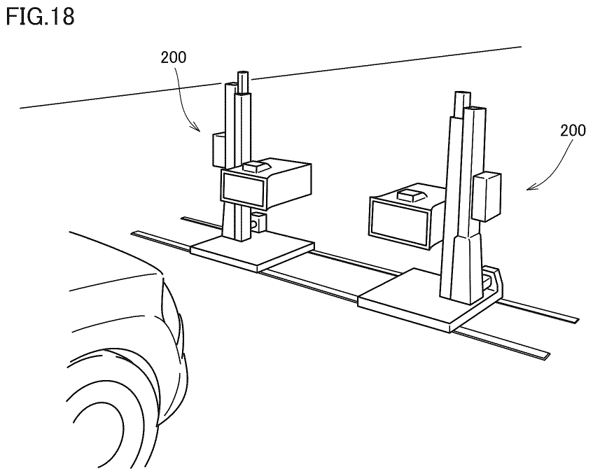

FIG. 18 is a schematic view showing an example of a headlight inspection device.

Referring to FIG. 18, a headlight inspection device 200 inspects the orientation of illumination and the brightness of a vehicle headlight. At this time, adjustment of an optical axis of the vehicle headlight is required. In adjustment of the optical axis of the headlight, it is necessary to acquire a reference position designated in advance in a lens of the headlight.

One method of acquiring the reference position is a method of regarding a center of gravity of a luminance distribution of light emitted by the headlight as the reference position. In this method, when the headlight has multiple light sources, the reference position determined from the center of gravity of the luminance distribution may not in some cases coincide with an original reference position preset in the headlight.

In addition, due to a temporal change in luminance distribution of the light, individual differences in manufacturing of components constituting the headlight, and the like, the stability of the reference position determined from the center of gravity of the luminance distribution may decrease.

In order to deal with this, the optical measurement method according to the present embodiment is used, whereby the reference position can be acquired based on a surface shape of the headlight, not the luminance distribution of the light.

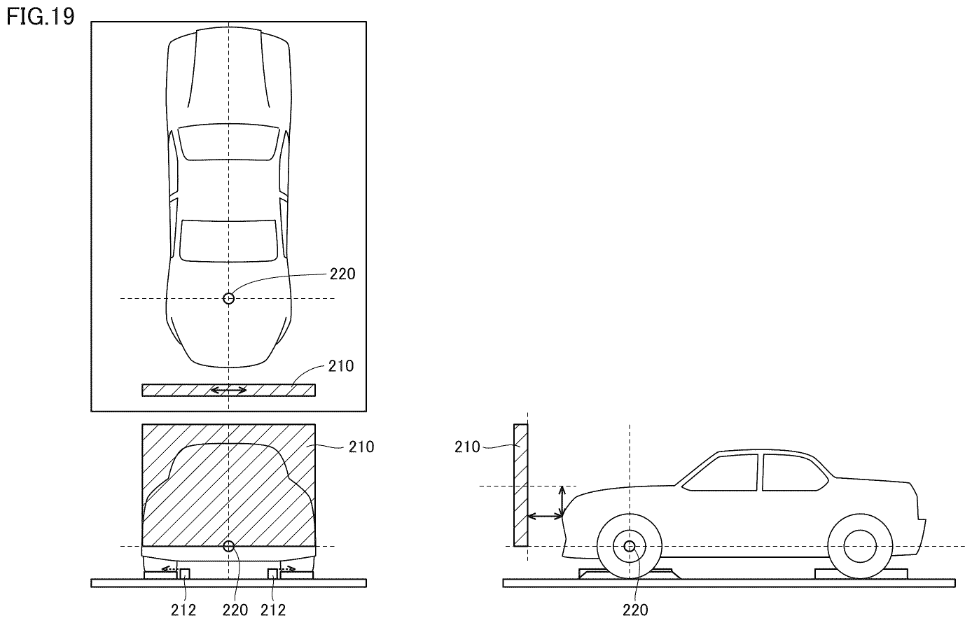

FIG. 19 is a schematic view showing an example of an inspection device for an advanced driver assistance system.

Referring to FIG. 19, at the time of inspection, a positional relationship between a fixed inspection device 210 and a vehicle (reference position 220) is adjusted using an alignment device 212. Alignment device 212 adjusts the vehicle to a direction (left-right direction) orthogonal to a direction in which the vehicle moves. However, since alignment device 212 aligns the vehicle by using a tire surface as an adjustment surface, alignment device 212 cannot in some cases regard a tire as a rigid body, and thus, the positional relationship between inspection device 210 and the vehicle cannot in some cases be adjusted appropriately.

In order to deal with this, the optical measurement method according to the present embodiment is used, whereby the reference position can be acquired based on a surface shape of the vehicle. Therefore, the positional relationship between inspection device 210 and the vehicle can be adjusted appropriately, and thus, inspection itself can also be performed appropriately.

As described above, the optical measurement method according to the present embodiment makes it possible to accurately and universally measure a position of an inspection facility on a real space and a position of a vehicle to be inspected on the real space. Therefore, the optical measurement method according to the present embodiment is applicable to various inspection processes for the vehicle.

### <I. Modifications>

The above-described embodiment can be modified in various manners.

### (i1: Uncertainty Present in Coordinate of Specific Point)

The three-dimensional point cloud data of object to be measured 40 includes uncertainty due to measurement fluctuations and the like. As a result, uncertainty is also present in the measured position (coordinate) of the specific point. Thus, a process of evaluating uncertainty present in the measured coordinate of the specific point may be executed.

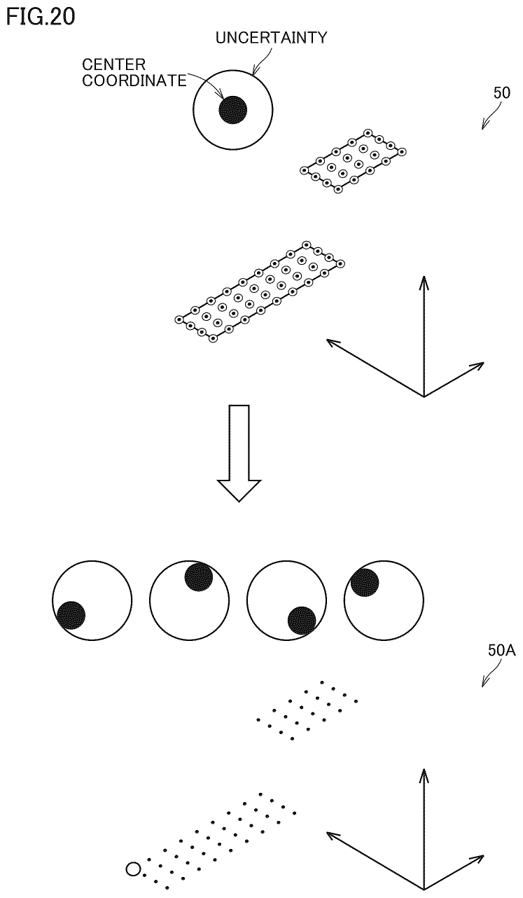

FIG. 20 is a diagram for illustrating a method of evaluating uncertainty present in a coordinate of a specific point in the optical measurement method according to the present embodiment.

Referring to FIG. 20, after scene point cloud data 50 of object to be measured 40 is acquired, a plurality of pieces of scene point cloud data 50A are randomly generated based on values of uncertainty present in respective points included in scene point cloud data 50. More specifically, the plurality of pieces of scene point cloud data 50A are generated by selecting one or more points included in scene point cloud data 50 and randomly correcting coordinates of the selected points in accordance with a normal distribution of the values of uncertainty.

The above-described process of measuring the position of the specific point is executed on the plurality of pieces of scene point cloud data 50A, thereby determining a coordinate of specific point 44 for each of the pieces of scene point cloud data 50A.

A standard deviation for the determined plurality of coordinates of specific point 44 may be calculated and the calculated standard deviation may be output as uncertainty present in the position of specific point 44.

As described above, optical measurement device 100 reflects uncertainty present in scene point cloud data 50 and generates the plurality of pieces of scene point cloud data 50A from scene point cloud data 50, calculates the coordinate corresponding to specific point 44 from each of the generated plurality of pieces of scene point cloud data 50A, and calculates uncertainty present in the calculated coordinate, based on variation in the calculated coordinate.

By calculating such uncertainty, the accuracy about the position of specific point 44 can be evaluated.

### (i2: Generation and Provision of Model)

Although the exemplary process of generating model 36 by using the three-dimensional point cloud data (reference point cloud data 30) of reference 20 has been described, model 36 may be generated by simulation by using computer aided design (CAD) data or the like without preparing real reference 20. In this case, three-dimensional point cloud data generated by disposing an object corresponding to reference 20 on a virtual space and performing virtual image pickup can be used.

In this case, by predefining a positional relationship between the real space and the virtual space, coordinate origin 4 of real space 2 required for model 36 can be acquired.

As described above, model 36 can be prepared without actually using reference 20, which makes it possible to deal with various objects to be measured 40.

Furthermore, a plurality of models 36 prepared in advance may be prestored in the server device or the like and downloaded by each of a plurality of optical measurement devices 100 as needed. The server device provides the plurality of models 36 to each of optical measurement devices 100 as appropriate, whereby even a user who does not have the prior knowledge for generating model 36 can easily use optical measurement device 100.

### (i3: Search Process)

Although the description above provides the exemplary process of searching for the pose that best aligns with scene point cloud data 50, by translating and rotating model point cloud data 32, the pose that best aligns with scene point cloud data 50 may be searched by only translating model point cloud data 32. When model point cloud data 32 is translated and rotated, a homogeneous transformation matrix including a translation matrix and a rotation matrix is calculated. On the other hand, when model point cloud data 32 is translated, a translation matrix is calculated. As described above, model point cloud data 32 may be only translated in the process of searching for the pose of model point cloud data 32 that best aligns with scene point cloud data 50.

For example, when it is ensured that object to be measured 40 does not rotate, the search time can be shortened.

Even when object to be measured 40 can rotate, a position of a specific point on object to be measured 40 can be measured more accurately by acquiring pieces of three-dimensional point cloud data using a plurality of cameras 10, conducting a search using models 36, and integrating search results.

### (i4: Output of Homogeneous Transformation Matrix)

Although the exemplary process of outputting the coordinate of specific point 44 on object to be measured 40 has been described, a homogeneous transformation matrix (or a translation matrix and/or a rotation matrix) may be output in addition to the coordinate of specific point 44 or instead of the coordinate of specific point 44.

The homogeneous transformation matrix indicates a deviation of object to be measured 40 from the reference position and the information about the deviation is useful in the inspection device and the like. Therefore, the calculated homogeneous transformation matrix (or the translation matrix and/or the rotation matrix) may be added to the inspection result by the inspection device.

As described above, the optical measurement method according to the present embodiment also includes the process of outputting the calculated homogeneous transformation matrix (or the translation matrix and/or the rotation matrix), in addition to the process of outputting the coordinate of specific point 44 on object to be measured 40.

### <J. Advantages>

In the optical measurement method according to the present embodiment, the position of the specific point on the real space can be measured in an optically non-contact manner. The object to be measured may have any shape. Even when the object to be measured can rotate, the position of the specific point on the real space can be measured.

One method of measuring the position on the real space is, for example, a method of bringing a probe or the like into physical contact with the object to be measured. However, from the perspective of quality and the like, this method is not applicable to an object to be measured with which the probe or the like cannot come into contact. In order to deal with this, in the optical measurement method according to the present embodiment, measurement can be performed in a non-contact manner, and thus, there is no such restriction.

In addition, one method of measuring the position on the real space is a method using pattern matching of a two-dimensional image. However, this method is vulnerable to noise and has difficulty in stable measurement. In addition, since the object to be measured and a template do not necessarily coincide with each other in terms of size and angle, it is necessary to prepare a plurality of templates in order to improve the robustness. In order to deal with this, in the optical measurement method according to the present embodiment, the position and/or the angle of the model that best aligns with the scene is searched by translating and/or rotating the model. Therefore, stable measurement can be performed and preparation of a plurality of models is unnecessary.

There is also a method of disposing a marker and the like on an object to be measured and calculating a positional relationship from data of images picked up by a plurality of cameras. In this method, it is necessary to dispose the marker and the like. In order to deal with this, in the optical measurement method according to the present embodiment, preparation of the model is only necessary and it is unnecessary to dispose the marker and the like on the object to be measured.

There is also a method of measuring one specific point using laser beams, ultrasonic waves or the like. In this method, it is necessary to dispose a plurality of sensors or the like and to perform complicated data processing on outputs of the plurality of sensors, in order to accurately measure a position. In order to deal with this, in the optical measurement method according to the present embodiment, measurement can be performed with high accuracy in a short time.

It should be understood that the embodiment disclosed herein is illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

2 real space; 4, 6 coordinate origin; 10 camera; 20 reference; 30 reference point cloud data; 32 model point cloud data; 34, 44 specific point; 36 model; 40 object to be measured; 50, 50A scene point cloud data; 100 optical measurement device; 102 processor; 104 memory; 106 storage; 108 input unit; 110 output unit; 112 camera interface; 114 media drive; 116 optical disk; 120 operating system; 122 model generation program; 124 measurement program; 126 model set; 128 program; 150 model generation unit; 152 model holding unit; 154 search unit; 156 coordinate calculation unit; 200 headlight inspection device; 210 inspection device; 212 alignment device; 220 reference position.

1. An optical measurement device comprising:
a holding unit that holds a model including a definition of a coordinate system of a real space, model point cloud data indicating a surface shape of an object serving as a reference of an object to be measured, and a coordinate of a specific point in the real space;
a search unit that searches for a pose of the model point cloud data that best aligns with three-dimensional point cloud data acquired from the object to be measured; and
a calculation unit that calculates, based on the searched pose, a coordinate corresponding to the specific point on the object to be measured.

2. The optical measurement device according to claim 1, wherein
the search unit searches for the pose that best aligns with the three-dimensional point cloud data, by translating and rotating the model point cloud data.

3. The optical measurement device according to claim 1, wherein
the search unit searches for the pose that best aligns with the three-dimensional point cloud data, by using downsampled data derived from the three-dimensional point cloud data and downsampled data derived from the model point cloud data.

4. The optical measurement device according to claim 1, wherein
the search unit extracts a predetermined number of pose candidates in descending order of a degree of similarity between the three-dimensional point cloud data and the model point cloud data.

5. The optical measurement device according to claim 4, wherein
the search unit evaluates uniqueness of a pose candidate having a highest degree of similarity, of the predetermined number of pose candidates, with respect to the other pose candidates.

6. The optical measurement device according to claim 1, further comprising
a model generation unit that determines, as the model point cloud data, partial data corresponding to one or more designated areas, with respect to three-dimensional point cloud data acquired from the object serving as the reference of the object to be measured.

7. The optical measurement device according to claim 1, wherein
the search unit
reflects uncertainty present in the three-dimensional point cloud data and generates a plurality of pieces of three-dimensional point cloud data from the three-dimensional point cloud data,
calculates a coordinate corresponding to the specific point from each of the generated plurality of pieces of three-dimensional point cloud data, and
calculates uncertainty present in the calculated coordinate, based on variation in the calculated coordinate.

8. An optical measurement method comprising:
acquiring a model including a definition of a coordinate system of a real space, model point cloud data indicating a surface shape of an object serving as a reference of an object to be measured, and a coordinate of a specific point in the real space;
searching for a pose of the model point cloud data that best aligns with three-dimensional point cloud data acquired from the object to be measured; and
calculating, based on the searched pose, a coordinate corresponding to the specific point on the object to be measured.

9. A non-transitory storage medium storing an optical measurement program thereon, when executed by one or more processors, causing the one or more processors to perform operations comprising:
acquiring a model including a definition of a coordinate system of a real space, model point cloud data indicating a surface shape of an object serving as a reference of an object to be measured, and a coordinate of a specific point in the real space;
searching for a pose of the model point cloud data that best aligns with three-dimensional point cloud data acquired from the object to be measured; and
calculating, based on the searched pose, a coordinate corresponding to the specific point on the object to be measured.

10. The optical measurement method according to claim 8, wherein
the searching comprises searching for the pose that best aligns with the three-dimensional point cloud data, by translating and rotating the model point cloud data.

11. The optical measurement method according to claim 8, wherein
the searching comprises searching for the pose that best aligns with the three-dimensional point cloud data, by using downsampled data derived from the three-dimensional point cloud data and downsampled data derived from the model point cloud data.

12. The optical measurement method according to claim 8, wherein
the searching comprises extracting a predetermined number of pose candidates in descending order of a degree of similarity between the three-dimensional point cloud data and the model point cloud data.

13. The optical measurement method according to claim 12, wherein
the searching comprises evaluating uniqueness of a pose candidate having a highest degree of similarity, of the predetermined number of pose candidates, with respect to the other pose candidates.

14. The optical measurement method according to claim 8, further comprising
determining, as the model point cloud data, partial data corresponding to one or more designated areas, with respect to three-dimensional point cloud data acquired from the object serving as the reference of the object to be measured.

15. The optical measurement method according to claim 8, further comprising
reflecting uncertainty present in the three-dimensional point cloud data and generating a plurality of pieces of three-dimensional point cloud data from the three-dimensional point cloud data,
calculating a coordinate corresponding to the specific point from each of the generated plurality of pieces of three-dimensional point cloud data, and
calculating uncertainty present in the calculated coordinate, based on variation in the calculated coordinate.

16. The non-transitory storage medium according to claim 9, wherein
the searching comprises searching for the pose that best aligns with the three-dimensional point cloud data, by translating and rotating the model point cloud data.

17. The non-transitory storage medium according to claim 9, wherein
the searching comprises searching for the pose that best aligns with the three-dimensional point cloud data, by using downsampled data derived from the three-dimensional point cloud data and downsampled data derived from the model point cloud data.

18. The non-transitory storage medium according to claim 9, wherein
the searching comprises extracting a predetermined number of pose candidates in descending order of a degree of similarity between the three-dimensional point cloud data and the model point cloud data.

19. The non-transitory storage medium according to claim 18, wherein
the searching comprises evaluating uniqueness of a pose candidate having a highest degree of similarity, of the predetermined number of pose candidates, with respect to the other pose candidates.

20. The non-transitory storage medium according to claim 9, wherein
the operations further comprise determining, as the model point cloud data, partial data corresponding to one or more designated areas, with respect to three-dimensional point cloud data acquired from the object serving as the reference of the object to be measured.
